(19) United States
(12) Patent Application Publication
(10) Pub. No.: US 2025/0285185 A1
(43) Pub. Date: Sep. 11, 2025

(54) GENERATION OF VISUALIZATIONS BASED ON MACHINE LEARNING OUTPUTS

(71) Applicant: ARGUS SOFTWARE, INC., Houston, TX (US)

(72) Inventors: Michael Jonathan Clawar, Durham, NC (US); Huiping Fang, Toronto (CA); Daniel Kaminsky, Raleigh, NC (US)

(21) Appl. No.: 18/598,515

(22) Filed: Mar. 7, 2024

(51) Int. Cl. G06Q 40/06

(52) U.S. Cl. CPC G06Q 40/06

(57) ABSTRACT

A method for providing a visualization explaining an output includes generating, by an engine and using a trained model, a predicted net operating income (NOI) and an explanation dataset for each asset in an asset dataset that is used as an input to the trained model and the explanation dataset includes deviations from a baseline dataset. The method also includes generating, by the engine, for at least one of the assets in the combined dataset, the visualization based on the predicted NOI and the explanation dataset. The visualization includes a total net impact based on a total difference between the predicted NOI and the baseline dataset and the deviations. Each of the deviations is based on one type from an economic and demographic dataset (EDD), and the deviations are displayed in an order based on the magnitude of the deviation.

### BACKGROUND

In the industry of commercial real estate (CRE, which is a feature that is used to generate profit or income), most industry professionals (e.g., debt brokers, individual investors, property managers, construction professionals, etc.) desire to quickly understand why a predicted value of an asset has been generated. Increasingly complicated tools to determine values are being generated to fine-tune a predicted value of an asset. However, as the complexity of these tools increases, it can be difficult for an industry professional to understand what is causing the predicted value of an asset.

### BRIEF DESCRIPTION OF DRAWINGS

Certain embodiments disclosed herein will be described with reference to the accompanying drawings. However, the accompanying drawings illustrate only certain aspects or implementations disclosed herein by way of example, and are not meant to limit the scope of the claims.

FIG. 1 shows a diagram of a system in accordance with one or more embodiments disclosed herein.

FIG. 2 shows a diagram of an infrastructure node (IN) in accordance with one or more embodiments disclosed herein.

FIG. 3 shows a method for generating training data for a model in accordance with one or more embodiments disclosed herein.

FIG. 4 shows a method for training a model in accordance with one or more embodiments disclosed herein.

FIGS. 5.1 and 5.2 show a method for creating a prediction for a value of an asset using a model and creating a visualization that explains what caused the value produced by the model in accordance with one or more embodiments disclosed herein.

FIG. 5 shows an example FRASP dataset in accordance with one or more embodiments disclosed herein.

FIG. 6 shows an example visualization in accordance with one or more embodiments disclosed herein.

FIG. 7 shows an example visualization in accordance with one or more embodiments disclosed herein.

FIG. 8 shows an example visualization in accordance with one or more embodiments disclosed herein.

FIG. 9 shows a diagram of a computing device in accordance with one or more embodiments disclosed herein.

### DETAILED DESCRIPTION

Specific embodiments will now be described in detail with reference to the accompanying figures. In the following detailed description of the embodiments, numerous specific details are set forth in order to provide a more thorough understanding of one or more embodiments. However, it will be apparent to one of ordinary skill in the art that the one or more embodiments may be practiced without these specific details. In other instances, well-known features have not been described in detail to avoid unnecessarily complicating the description.

In the following description of the figures, any component described with regard to a figure, in various embodiments, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, valuation (or asset valuation) is considered as a core part of CRE. Reliably predicting a value of a real estate asset (e.g., a real property asset, a real asset, etc.) is essential for all parts of a real estate lifecycle, including but not limited to, capital raising, development, acquisition, portfolio management, disposition, etc. As such, the complexity in arriving at a valuation or predicted valuation for assets is becoming increasingly complex to the point that a person is unable to understand how the valuation or predicted valuation was generated. In turn, real estate professionals are unable to use the valuations or predicted valuations to understand what actions to take in response to the valuations or predicted valuations.

For at least the reasons discussed above, an explanation of how the valuations are being generated is needed. Further, the explanations are used to provide a real estate professional a greater understanding of a valuation. As such, the manner in which the explanation is presented may be equally important as the valuation itself. In order to address the shortcomings of current valuation approaches and explanations of valuations, embodiments disclosed herein relate to a system and method for creating a valuation model that is capable of creating explanations and visualizations of the explanations that cause, and by how much each causes, the output of the valuation model, thereby enabling real estate professionals to have the explanation information available to them, but also presented in a manner that is easy to digest. The visualizations also enable non-real estate professionals to easily digest the explanation information, thereby enabling a broader group of individuals to take advantage of the valuation model.

The following describes various embodiments disclosed herein.

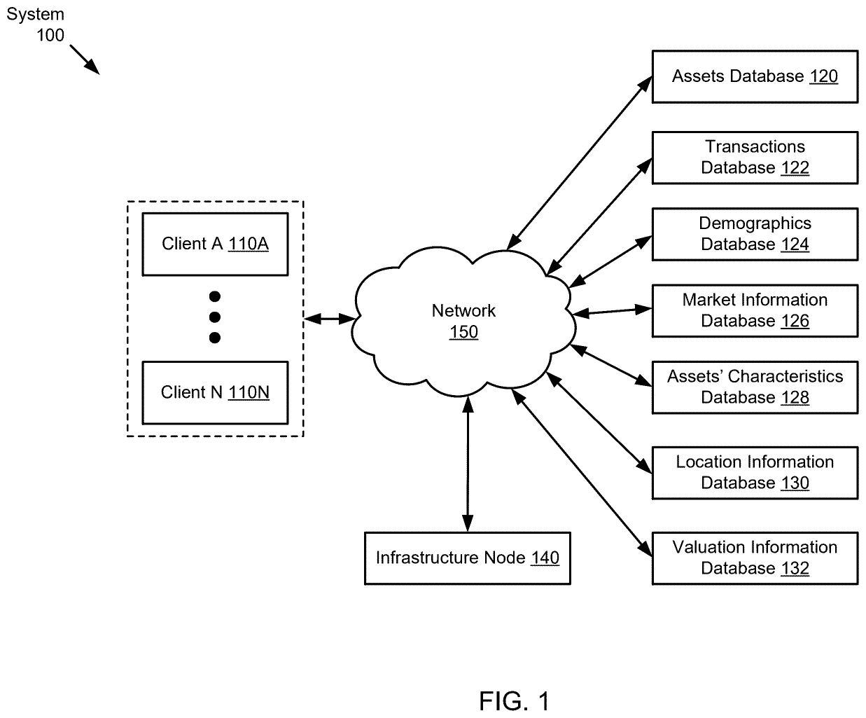

FIG. 1 shows a diagram of a system (100) in accordance with one or more embodiments. The system (100) includes any number of clients (e.g., Client A (110A), Client B (110B), etc.), one or more databases (120-132), a network (150), and an infrastructure node (IN) (140). The system (100) may include additional, fewer, and/or different components without departing from the scope of the embodiment disclosed herein. Each component may be operably connected to any of the other components via any combination of wired and/or wireless connections. Each component illustrated in FIG. 1 is discussed below.

In one or more embodiments, the clients (e.g., 110A, 110B, etc.), the databases (120-132), and the IN (140) may be physical or logical devices, as discussed below. While FIG. 1 shows a specific configuration of the system (100), other configurations may be used without departing from the scope of the embodiments disclosed herein. For example, although the clients (e.g., 110A, 110B, etc.) and the IN (140) are shown to be operatively connected through a communication network (e.g., 150), the clients (e.g., 110A, 110B, etc.) and the IN (140) may be directly connected (e.g., without an intervening communication network).

Further, the functioning of the clients (e.g., 110A, 110B, etc.) and the IN (140) is not dependent upon the functioning and/or existence of the other components (e.g., devices) in the system (100). Rather, the clients (e.g., 110A, 110B, etc.) and the IN (140) may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. Further, as used herein, the term “data” is intended to be broad in scope. In this manner, that term embraces, for example (but not limited to): data segments that are produced by data stream segmentation processes, data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the disclosure are not limited to any particular form of representing and storing data or other information. Rather, such principles are equally applicable to any object capable of representing information.

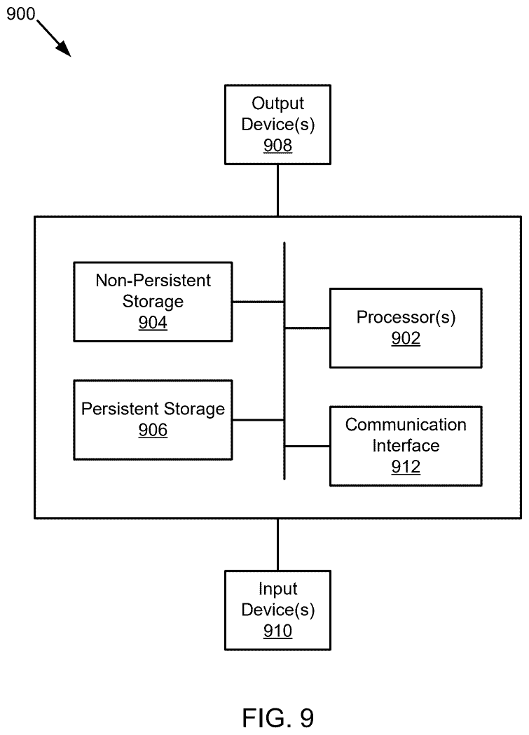

In one or more embodiments, the system (100) may represent a distributed system (e.g., a distributed computing environment, a cloud computing infrastructure, etc.) that delivers at least computing power (e.g., real-time network monitoring, server virtualization, etc.), storage capacity (e.g., data backup), and data protection (e.g., software-defined data protection, disaster recovery, etc.) as a service to users (e.g., end-users) of the clients (e.g., 110A, 110B, etc.). The system (100) may also represent a comprehensive middleware layer running on computing devices (e.g., 900, FIG. 9) that supports virtualized application environments. In one or more embodiments, the system (100) may support a virtual machine (VM) environment, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide the aforementioned computer-implemented services to the users, the system (100) may perform some computations (e.g., data collection, distributed processing of collected data, etc.) locally (e.g., at the users' site using the clients (e.g., 110A, 110B, etc.)) and other computations remotely (e.g., away from the users' site using other environments (e.g., 140)) from the users. By doing so, the users may utilize different computing devices (e.g., 1100, FIG. 11) that have different quantities of computing resources (e.g., processing cycles, memory, storage, etc.) while still being afforded a consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, the IN (140) may include (i) a chassis configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

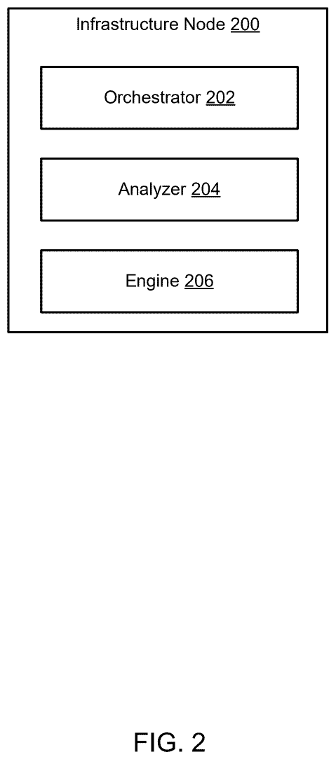

In one or more embodiments, as being a physical computing device or a logical computing device, the IN (140) may be configured for, e.g.: (i) hosting and maintaining various workloads, (ii) providing a computing environment whereon workloads may be implemented, (iii) providing computer-implemented services to one or more entities, (iv) exchanging data with other components registered in/to the network (150) in order to, for example, participate in a collaborative workload placement (e.g., the IN (140) may split up a request (e.g., an operation, a task, an activity, etc.) with another IN in the system (100), coordinating its efforts to complete the request more efficiently than if the IN (140) had been responsible for completing the request), (v) operating as a standalone device, (vi) providing software-defined data protection for the clients (e.g., 110A, 110B, etc.), (vii) providing automated data discovery, protection, management, and recovery operations for the clients, (viii) providing data deduplication, (ix) orchestrating data protection through one or more GUIs, (x) empowering data owners (e.g., users of the clients) to perform self-service data backup and restore operations from their native applications, (xi) ensuring compliance and satisfy different types of service level objectives (SLOs) set by an administrator, (xii) simplifying VM image backups of a VM with near-zero impact on the VM, (xiii) increasing resiliency of an organization by enabling rapid recovery or cloud disaster recovery from cyber incidents, (xiv) providing long-term data retention (in conjunction with the databases (120)), (xv) providing operational simplicity, agility, and flexibility for physical, virtual, and cloud-native environments, (xvi) consolidating multiple data process or protection requests (received from, for example, the clients) so that duplicative operations (which may not be useful for restoration purposes) are not generated, and/or (xvii) initiating multiple data process or protection operations in parallel (e.g., an analyzer (e.g., 204, FIG. 2) may host multiple operations, in which each of the multiple operations may (a) manage the initiation of a respective operation and (b) operate concurrently to initiate multiple operations). In one or more embodiments, in order to read, write, or store data, the IN (140) may communicate with, for example, a storage array (not shown) and/or the databases (120).

As described above, the IN (140) may be capable of providing a range of functionalities/services to the users of the clients (e.g., 110A, 110B, etc.). However, not all of the users may be allowed to receive all of the services. To manage the services provided to the users of the clients, a system (e.g., a service manager) in accordance with embodiments may manage the operation of a network (e.g., 150), in which the clients are operably connected to the IN (140). Specifically, the service manager (i) may identify services to be provided by the IN (140) (for example, based on the number of users using the clients) and (ii) may limit communications of the clients to receive IN provided services.

As used herein, a “workload” is a physical or logical component configured to perform certain work functions. Workloads may be instantiated and operated while consuming computing resources allocated thereto. A user may configure a data protection policy for various workload types.

Further, while a single IN (or IHS) is considered above, the term “system” includes any collection of systems or sub-systems that individually or jointly execute a set, or multiple sets, of instructions to provide one or more computer-implemented services. For example, a single IN may provide a computer-implemented service on its own (i.e., independently) while multiple other INs may provide a second computer-implemented service cooperatively (e.g., each of the multiple other information handling systems may provide similar and or different services that form the cooperatively provided service).

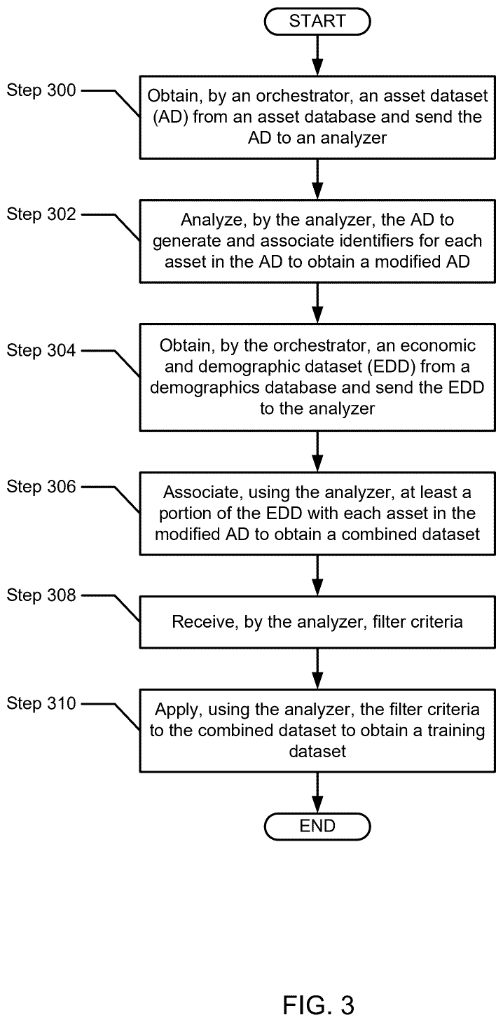

In one or more embodiments, the instructions may embody one or more of the methods or logic in FIGS. 3-5.2. In a particular embodiment, the instructions may reside completely, or at least partially, within a storage/memory resource (described below) of the IN (140) or another memory included in the IN, and/or within a processing resource (described below) of the IN (140) during execution by the IN.

In one or more embodiments, the IN (140) may provide computer-implemented services to users (and/or other computing devices such as, for example, other clients or other types of components). As described above, the IN (140) may provide any quantity and any type of computer-implemented services. To provide computer-implemented services, the IN (140) may include a collection of physical components (described below) configured to perform operations of the IN (140) and/or otherwise execute a collection of logical components (described below) of the IN (140).

In one or more embodiments, a processing resource (not shown) may refer to a measurable quantity of a processing-relevant resource type, which may be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a virtual CPU (vCPU), a virtual GPU (vGPU), a virtual DPU (vDPU), a computation acceleration resource, an application-specific integrated circuit (ASIC), a digital signal processor for facilitating high-speed communication, etc.

In one or more embodiments, a storage and/or memory resource (not shown) may refer to a measurable quantity of a storage/memory-relevant resource type, which can be requested, allocated, and consumed. A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, dynamic RAM (DRAM), etc.

In one or more embodiments, the IN (140) may include a memory management unit (MMU) (not shown), in which the MMU is configured to translate virtual addresses (e.g., those of a virtual address space (discussed below)) into physical addresses (e.g., those of memory). In one or more embodiments, the MMU may be operatively connected to the storage/memory resources, and the MMU may be the sole path to access the memory, as all data destined for the memory must first traverse the MMU prior to accessing the memory. Further, the MMU may be configured to: (i) provide memory protection (e.g., allowing only certain applications to access memory) and (ii) provide cache control and bus arbitration.

Additional details of the IN are described below in reference to FIG. 2.

In one or more embodiments, the IN (140) may be implemented as a computing device (e.g., 1100, FIG. 11). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., HDDs, SSDs, etc.). The computing device may include instructions, stored in the persistent storage, that when executed by the processor(s) of the computing device cause the computing device to perform the functionality of the IN (140) described throughout this application.

Alternatively, in one or more embodiments, the IN (140) may be implemented as a logical device. The logical device may utilize the computing resources of any number of computing devices to provide the functionality of the IN (140) described throughout this application.

Turning now to the mapping server (150), the mapping server (150) may split up a request with another component of the system (100), coordinating its efforts to complete the request (e.g., to generate a response) more efficiently than if the mapping server (150) had been responsible for completing the request. In one or more embodiments, a request may be, for example (but not limited to): a web browser search request, a representational state transfer (REST) request, a computing request (e.g., a unique asset fingerprint generation request received from the IN (140)), a database management request, a registration request, a file upload/download request, etc.

To provide any computer-implemented services to one or more entities, the mapping server (150) may perform computations locally and/or remotely. By doing so, the mapping server (150) may utilize different computing devices that have different quantities of computing resources to provide a consistent experience to the entities. In one or more embodiments, the mapping server (150) may be a heterogeneous set, including different types of hardware components and/or different types of operating systems (OSs) (e.g., the mapping server (150) may have less, the same, or more computing resources (described above) comparing to the IN (140)).

In one or more embodiments, a number of databases are included, and consist of, at least, an assets database (120), a transactions database (122), a demographics database (124), a market information database (126), an assets' characteristics database (128), a location information database (130), and a valuation information database (132), which may collectively be referred to as “the databases”. In one or more embodiments, one or more of the databases is a fully managed cloud (or local) database (or any logical container) that acts as a shared storage and/or memory (simply “storage/memory”) resource that is functional to store unstructured and/or structured data (e.g., each database may have dissimilar types of data/records and store the data in different formats). Further, the database may also occupy a portion of a physical storage/memory device or, alternatively, may span across multiple physical storage/memory devices.

In one or more embodiments, one or more of the databases is implemented using physical devices that provide data storage services (e.g., storing data and providing copies of previously stored data). The devices that provide data storage services may include hardware devices and/or logical devices. For example, the database may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database may include a memory device (e.g., a dual in-line memory device), in which data is stored and from which copies of previously stored data are provided. As yet another example, the database may include a persistent storage device (e.g., an SSD), in which data is stored and from which copies of previously stored data is provided. As yet another example, the database may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

In one or more embodiments, one or more of the databases is implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the assets database (120) may store/log/record (temporarily or permanently) unstructured and/or structured data (associated with one or more assets) that may include (or specify), for example (but not limited to): in-place leases, in-place rent rolls (including all contract terms such as step-ups, expiry, renewal options, tenant improvements, free rent, etc.), known operating expenses (e.g., Organization D has a contracted lease for 10 k square feet in an office asset and the asset owner knows with high-confidence that the 10 k square feet requires a contact with a janitorial vendor for $1 k/month, which is a known operating expense; a landscaping fee; a pes control fee; a utility fee; an insurance fee; etc.), known capital expenditures (e.g., an asset owner has a capital expenditure plan in place that is actively being rolled out to renovate two floors of its office asset and replace plumbing, flooring, and walls, in which the plan has a known budget and timeline for outlays from the owner and this would be considered as a known capital expenditure; a fee to replace an asset's roof; a fee to replace an asset-wide air conditioning system; a fee to implement a newer asset automation system; etc.), county asset tax records (which may be available from government or other organizations), parcel records, etc. Based on the aforementioned data, for example, the IN (140) may perform asset analytics to infer profiles of assets available in a specific region/location.

In one or more embodiments, the transactions database (122) may store/log/record (temporarily or permanently) unstructured and/or structured data (associated with one or more assets) that may include (or specify), for example (but not limited to): location information, a type of a sale event (e.g., a full or partial sale event), a price of a sale event, a close date of an asset, a recorded date of an asset, etc. Based on the aforementioned data, for example, the IN (140) may perform user/tenant analytics to infer profiles of existing users in a specific region.

In one or more embodiments, the demographics database (124) may store/log/record (temporarily or permanently) unstructured and/or structured data (associated with one or more assets) that may include (or specify), for example (but not limited to): population information, income information, employment information, a migration pattern, median home value in the communities in a surrounding area (e.g., at any scale, including only an area immediately surrounding the asset, a regional area (i.e., a metropolitan and/or state-wide region), or a national area), population of the communities in the surrounding area; gross annual productivity of the county, percentage of community within a in the surrounding area that does not have health insurance, median household income of the communities in the surrounding area, percentage growth of the median home value in the communities in the surrounding area compared to a point in the past (e.g., 2 years ago, 5 years ago, etc.), historical volatility of the gross product in the surrounding area, which may be compared to the gross domestic product volatility of a larger area (e.g., the United States), employment diversity index of the communities in the surrounding area; distance to closest shipping location, population within the surrounding area; median home value within the surrounding area, county-level permits growth divided by household growth; percentage of households in the surrounding area that are high income renters (persons having an income over $75,000/year), FEMA National Risk Index for the census tract; median income of renters in the surrounding area, percentage of households in the surrounding area that are married with children, percentage of households in the surrounding area that are renters, percentage of employment in higher income sectors (e.g., finance, technology, legal, medicine, etc.), index of employment diversity in the surrounding area, and tract-based median home value. Based on the aforementioned data, for example, the IN (140) may perform user analytics to infer profiles of existing users in a specific region.

As used herein, income may refer to all revenue (rental or otherwise) such as, for example, revenue generated by an asset less expenses associated with the asset (excluding interest payments for debt).

In one or more embodiments, the market information database (126) may store/log/record (temporarily or permanently) unstructured and/or structured data (associated with one or more assets) that may include (or specify), for example (but not limited to): existing “asset” supply information, vacancy information, supply net absorption (e.g., if 100 k square feet of space has been vacated by departing tenants in an asset during May, but 50 k square feet of space has been taken up by new tenants moving in, then the net absorption will be −50 k square feet), asking rent information (e.g., a list price of an asset for rent), new supply pipeline (e.g., new supply pipeline refers to new space (which may be occupied by a renter or an owner) that would impact the market dynamics for an existing asset, in which the new space may be generated by (i) new assets being constructed, (ii) renovations of existing assets to convert previously non-competitive space to a competitive space (for example, if the IN (140) is evaluating a multifamily apartment asset, an office asset nearby converted to apartments would be competitive space), and/or (iii) additions to existing assets to add an area, etc.), etc. Based on the aforementioned data, for example, the IN (140) may perform CRE market analytics to infer latest trends and/or profiles of assets in a specific region.

In one or more embodiments, the assets' characteristics database (128) may store/log/record (temporarily or permanently) unstructured and/or structured data (associated with one or more assets) that may include (or specify), for example (but not limited to): an age of an asset, building quality of an asset, a size of an asset (e.g., a number of stories, a number of elevators, an amount of square footage, an amount of outdoor space, etc.), a size of a lot (e.g., a lot size depth in feet, a lot size frontage in feet, etc.), a description of an asset (which may be defined based on a geographic location of the asset), an attribute of an asset (e.g., amenities provided by an asset, renovations required for the asset, the market value for renovations, the market value of the land, the sum of commercial units, the sum of residential units, the year the asset was built, the sum of full baths, the sum of half baths, a number of rooms, the longitude and latitude of the asset, the number of tenants, the tenants per asset area, etc.), a type of an asset (e.g., retail, industrial, office, multifamily, hospitality, public and semi-public, agricultural, easements/other, special purpose, tax exempt, vacant land, no asset type (if enough asset type information is not available), etc.), asset and land characteristics form image data, etc. Based on the aforementioned data, for example, the IN (140) may perform asset analytics to infer characteristics of the corresponding asset(s).

In one or more embodiments, the location information database (130) may store/log/record (temporarily or permanently) unstructured and/or structured data (associated with one or more assets) that may include (or specify), for example (but not limited to): points of interest nearby (e.g., a coffee shop, a park, etc.), zoning codes (including state and/or country information), a distance to a transportation system (e.g., a subway, a bus, a train station, etc.), transit times information, etc. Based on the aforementioned data, for example, the IN (140) may perform location analytics to infer profiles of existing users/tenants and environment in a specific region (e.g., a high-end tenant (e.g., an executive, an attorney, etc.) that lives in an environment that requires minimum capital expenditures and includes well-kept playgrounds for kids).

In one or more embodiments, the valuation information database (132) may store/log/record (temporarily or permanently) unstructured and/or structured data (associated with one or more assets) that may include (or specify), for example (but not limited to): location information of an asset, asset information regarding valuation “as of” date, etc. Based on the aforementioned data, for example, the IN (140) may perform valuation analytics to infer profiles of existing users and environment in a specific region.

In one or more embodiments, the unstructured and/or structured data may be updated (automatically) by third party systems (e.g., platforms, marketplaces, etc.) (provided by vendors) or by administrators based on, for example, newer (e.g., updated) attributes (of an asset) being available. The unstructured and/or structured data may also be updated when, for example (but not limited to): there is a change in population information, there is change in income information, etc.

In one or more embodiments, one or more of the databases is an indexing service. For example, an agent (not shown) of the database may receive various model training related inputs directly (or indirectly) from the IN (140). Upon receiving, the agent may analyze those inputs to generate an index(es) (e.g., a training process index(es)) for optimizing the performance of the database by reducing a required amount of database access(es) when implementing a request (e.g., a data retrieval request received from the IN (140)). In this manner, requested data may be quickly located and accessed from the database using an index of the requested data. In one or more embodiments, an index may refer to a database structure that is defined by one or more field expressions. A field expression may be a single field name such as “user_number”. For example, an index (e.g., E41295) may be associated with “user_name” (e.g., Adam Smith) and “user_number” (e.g., 012345), in which the requested data is “Adam Smith 012345”.

In one or more embodiments, the unstructured and/or structured data may be maintained by, for example, the IN (140) and/or an administrator of the IN (140). The IN (140) and/or the administrator may add, remove, and/or modify those data in one or more of the databases to cause the information included in the one or more databases to reflect the latest version of, for example, income information. The unstructured and/or structured data available in the one or more databases may be implemented using, for example, lists, tables, unstructured data, structured data, etc. While described as being stored locally, the unstructured and/or structured data may be stored remotely, and may be distributed across any number of devices without departing from the scope disclosed herein.

While one or more of the databases has been illustrated and described as including a limited number and type of data, the database may store additional, less, and/or different data without departing from the scope. One of ordinary skill will appreciate that the database may perform other functionalities without departing from the scope disclosed herein. When providing its functionalities, the database may perform all, or a portion, of the methods illustrated in FIGS. 3-5.2. The database may be implemented using hardware, software, or any combination thereof.

In one or more embodiments, a client (e.g., 110A, 110B, etc.) may be a physical or logical computing device configured for hosting one or more workloads, or for providing a computing environment whereon workloads may be implemented. The client may correspond to a computing device that one or more users use to interact with one or more components of the system (100).

In one or more embodiments, different clients (e.g., 110A, 110B, etc.) may have different computational capabilities. For example, Client A (110A) may have 16 gigabytes (GB) of DRAM and 1 CPU with 12 cores, whereas Client N (110N) may have 8 GB of PMEM and 1 CPU with 16 cores. Other different computational capabilities of the clients (e.g., 110A, 110B, etc.) not listed above may also be taken into account without departing from the scope.

In one or more embodiments, a client (e.g., 110A, 110B, etc.) may include any number of applications (and/or content accessible through the applications) that provide computer-implemented application services to a user. Applications may be designed and configured to perform one or more functions instantiated by a user of the client. Examples of an application may include (but not limited to): a word processor, a media player, a web browser, a file viewer, an image editor, etc.

In order to provide application services, each application may host similar or different components. The components may be, for example (but not limited to): instances of databases, instances of email servers, etc. Applications may be executed on one or more clients as instances of the application.

In one or more embodiments, applications may vary in different embodiments, but in certain embodiments, applications may be custom developed or commercial applications that a user desires to execute in a client (e.g., 110A, 110B, etc.). In one or more embodiments, applications may be logical entities executed using computing resources of a client (e.g., 110A, 110B, etc.). For example, applications may be implemented as computer instructions, e.g., computer code, stored on persistent storage of the client that when executed by the processor(s) of the client cause the client to provide the functionality of the applications described throughout the application.

In one or more embodiments, while performing, for example, one or more operations requested by a user, applications installed on a client (e.g., 110A, 110B, etc.) may include functionality to request and use physical and logical components/resources of the client. Applications may also include functionality to use data stored in storage/memory resources of the client. The applications may perform other types of functionalities not listed above without departing from the scope. In one or more embodiments, while providing application services to a user, applications may store data that may be relevant to the user in storage/memory resources of a client (e.g., 110A, 110B, etc.).

In one or more embodiments, a client (e.g., 110A, 110B, etc.) may interact with the IN (140). For example, the client may issue requests to the IN (140) to receive responses and interact with various components of the IN (140). The client may also request data from and/or send data to the IN (140). As yet another example, a client (e.g., 110A, 110B, etc.) may utilize application services provided by the IN (140). When the client interacts with the IN (140), data that is relevant to the client may be stored (temporarily or permanently) in the IN (140).

As yet another example, consider a scenario in which the IN (140) hosts a database utilized by a client (e.g., 110A, 110B, etc.). In this scenario, the database may be a client database associated with users of the client. When a new user is identified, the client may add information of the new user to the client database. By doing so, data that is relevant to the client may be stored in the IN (140). This may be done because the client may desire access to the information of the new user at some point-in-time.

As yet another example, a client (e.g., 110A, 110B, etc.) may execute an application that interacts with an application database hosted by the IN (140). When an application upgrade is available to fix a critical software issue, the IN (140) may identify the client that requires the application upgrade. The application database may then provide the application upgrade to the client. By doing so, the application executed by the client may be kept up-to-date. As yet another example, a client (e.g., 110A, 110B, etc.) may send instructions to the IN (140) to configure one or more VMs hosted by the IN (140). In one or more embodiments, instructions may be, for example (but not limited to): instructions to configure a backup policy, instructions to take a snapshot of VM data, etc.

In one or more embodiments, to provide a consistent user experience to a user, a client (e.g., 110A, 110B, etc.) may implement virtualized (or virtual) desktop infrastructure (VDI) environment or other types of computing environments that enable remote resources (e.g., of the IN (140)) to provide computer-implemented services that appear to the user to be provided by the client. Said another way, the IN (140) may facilitate VDI functionalities of the client, in which the IN (140) may perform computations on behalf of the VDI environment(s) implemented/used by the client and provide the results of the computations to the client. By doing so, the client may be able to provide functionalities that would otherwise be unavailable due to the lack of computing resources and/or software implemented functionalities of the client.

In this manner, the client may be capable of, e.g.: (i) collecting users' inputs, (ii) correlating collected users' inputs to the computer-implemented services to be provided to the users, (iii) communicating with the IN (140) that perform computations necessary to provide the computer-implemented services, (iv) using the computations performed by the IN (140) to provide the computer-implemented services in a manner that appears (to the users) to be performed locally to the users, and/or (v) communicating with any virtual desktop (VD) in a VDI environment of the IN (140) (using any known protocol in the art), for example, to exchange remote desktop traffic or any other regular protocol traffic (so that, once authenticated, users may remotely access independent VDs (which may accommodate customized settings) via the client).

In one or more embodiment, a VDI environment (or a virtualized architecture) may be employed for numerous reasons, for example (but not limited to): to manage resource (or computing resource) utilization, to provide cost-effective scalability across multiple servers, to provide a workload portability across multiple servers, to streamline an application development by certifying to a common virtual interface rather than multiple implementations of physical hardware, to encapsulate complex configurations into a file that is easily replicated and provisioned, etc.

In one or more embodiments, a client (e.g., 110A, 110B, etc.) may be implemented as a computing device (e.g., 900, FIG. 9). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client (e.g., 110A, 110B, etc.) described throughout the application.

Alternatively, in one or more embodiments, similar to the IN (140), the client (e.g., 110A, 110B, etc.) may also be implemented as a logical device.

In one or more embodiments, users may interact with (or operate) a client (e.g., 110A, 110B, etc.) in order to perform work-related tasks (e.g., production workloads). In one or more embodiments, the accessibility of users to the client may depend on a regulation set by an administrator of the client. To this end, each user may have a personalized user account that may, for example, grant access to certain data, applications, and computing resources of the client. This may be realized by implementing the “virtualization” technology. In one or more embodiments, an administrator may be a user with permission (e.g., a user that has root-level access) to make changes on the client that will affect other users of the client.

In one or more embodiments, for example, a user may be automatically directed to a login screen of the client when the user connected to that client. Once the login screen of the client is displayed, the user may enter credentials (e.g., username, password, etc.) of the user on the login screen. The login screen may be a GUI generated by a visualization module (not shown) of the client. In one or more embodiments, the visualization module may be implemented in hardware (e.g., circuitry), software, or any combination thereof.

In one or more embodiments, the GUI may be displayed on a display of a computing device (e.g., 900, FIG. 9) using functionalities of a display engine (not shown), in which the display engine is operatively connected to the computing device. The display engine may be implemented using hardware, software, or any combination thereof. The login screen may be displayed in any visual format that would allow the user to easily comprehend (e.g., read and parse) the listed information.

In one or more embodiments, the network (150) (or the “network environment”) may represent a (decentralized or distributed) computing network and/or fabric configured for computing resource and/or messages exchange among registered computing devices (e.g., the clients (e.g., 110A, 110B, etc.), the IN (140), etc.). As discussed above, components of the system (100) may operatively connect to one another through the network (150) (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (150) may be implemented using any combination of wired and/or wireless network topologies, and the network (150) may be operably connected to the Internet or other networks. Further, the network (150) may enable interactions between, for example, the clients and the IN through any number and type of wired and/or wireless network protocols (e.g., TCP, UDP, IPv4, etc.). Further, the network (150) may be configured to perform all, or a portion, of the functionality described in FIGS. 3-5.2.

The network (150) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network (150), and (iii) limiting communication(s) on a granular level (e.g., on a per-port level, on a per-sending device level, etc.). The network (150) and its subcomponents may be implemented using hardware, software, or any combination thereof.

Turning now to FIG. 2, FIG. 2 shows a diagram of an IN (200) in accordance with one or more embodiments disclosed herein. The IN (200) may be an example of an IN discussed above in reference to FIG. 1. The IN (200) may include an orchestrator (202), an analyzer (204), and an engine (206). The IN (200) may include additional, fewer, and/or different components without departing from the scope. Each component may be operably connected to any of the other component via any combination of wired and/or wireless connections. Each component illustrated in FIG. 2 is discussed below.

In one or more embodiments, the orchestrator (202) may include functionality to, e.g.: (i) monitor/aggregate/track various performance and health (e.g., operation condition) information of the analyzer (204) and the engine (206); (ii) obtain (or retrieve) an asset dataset (AD) (described below) from the assets database (e.g., 120, FIG. 1) and provide/send the AD to the analyzer (204); (iii) obtain (or retrieve) a sale transactions dataset (STD) (described below) from the transactions database (e.g., 122, FIG. 1) and provide/send the STD to the analyzer (204); (iv) obtain (or retrieve) an economic and demographic dataset (EDD) (described below) from the demographics database (e.g., 124, FIG. 1) and provide/send the EDD to the analyzer (204); (v) obtain (or retrieve) a market dataset (described below) from the market information database (e.g., 126, FIG. 1) and provide/send the market dataset to the analyzer (204); (vi) obtain (or retrieve) an asset characteristics dataset (ACD) (described below) from the assets' characteristics database (e.g., 128, FIG. 1) and provide/send the ACD to the analyzer (204); (vii) obtain (or retrieve) a location dataset (LD) (described below) from the location information database (e.g., 130, FIG. 1) and provide/send the LD to the analyzer (204); (viii) obtain (or retrieve) a valuation asset dataset (VAD) (described below) from the valuation information database (e.g., 132, FIG. 1) and provide/send the VAD to the analyzer (204); (ix) support fundamental IN functions (e.g., schedule tasks, allocate IN resources, execute management applications and/or processes, manage peripherals (e.g., I/O devices) connected to the IN (200), etc.); and/or (x) store (temporarily or permanently) information/data related to (i)-(ix) in a storage/memory resource of the IN (200).

In one or more embodiments, the AD may include (or specify), for example (but not limited to): an in-place lease document, information in relation to an in-place rent roll, information in relation to a known operating expense, information in relation to known capital expenditure, information in relation to a lease expiry date and time, county asset tax records, information in relation to a lease renewal option, information in relation to a tenant improvement, information in relation to a free rent period, parcel records, etc.

In one or more embodiments, the STD may include (or specify), for example (but not limited to): a sales price of an asset, location information, a type of a sale event, a price of a sale event, a close date of an asset, a recorded date of an asset, etc.

In one or more embodiments, the EDD may include (or specify), for example (but not limited to): a population of an area/region, an average income of a person living in the area, a type of an employment available in the area, information in relation to a migration pattern in the area, etc.

In one or more embodiments, the MD may include (or specify), for example (but not limited to): existing asset supply information, a vacancy status of an asset, information in relation to supply net absorption, information in relation to a new supply pipeline, information in relation to an asking rent, etc.

In one or more embodiments, the ACD may include (or specify), for example (but not limited to): an age of an asset, a health condition of an asset, building quality of an asset (e.g., a subjective rating, typically with A being the highest quality asset, followed by B and C, and D being the lowest quality asset), a size of an asset, a size of a lot that hosts an asset, a description of an asset, an attribute of an asset, a type of an asset, asset and land characteristics form image data, a net rentable area (e.g., how much space can be rented), a number of units (e.g., for a multifamily asset), presence of amenities (e.g., a pool, a doorman, etc.), a location address of an asset, etc.

In one or more embodiments, the LD may include (or specify), for example (but not limited to): a point of interest nearby an asset, a zoning code, a distance to a transportation system, information in relation to transit times, information in relation to a geographic region, a type of a tenant (e.g., a high-end tenant that requires a high-end asset in a rich environment, a low-end tenant, etc.), etc.

In one or more embodiments, the VAD may include (or specify), for example (but not limited to): location information of an asset, asset information regarding valuation “as of” date, etc. In one or more embodiments, the VAD either has to include the required information from the AD (e.g., in-place leases, rent rolls, known operating expenses, known capital expenditures, etc.), or the AD must include this information for a valuation asset already. In the latter case, the VAD may actually just have the location information of the asset and the asset information regarding valuation as of date because the above required information may be obtained from the AD.

One of ordinary skill will appreciate that the orchestrator (202) may perform/provide other functionalities without departing from the scope. When providing its functionalities, the orchestrator (202) may perform all, or a portion, of the methods illustrated in FIGS. 3-5.2. The orchestrator (202) may be implemented using hardware, software, or any combination thereof.

In one or more embodiments, the analyzer (204) may include functionality to, e.g.: (i) analyze an AD (which is received from the orchestrator (202)) to generate a generate and associate identifiers for each asset in the AD to obtain a modified AD; (ii) associate a portion of the EDD (which is received from the orchestrator (202)) with each asset in the modified AD to obtain a combined dataset; (iii) apply filter criteria to the combined data set to obtain a training dataset and/or an augmented dataset; (iv) instruct an engine (e.g., the engine (206)) to generate outputs (described below); (v) initiate a display of visualizations generated by the engine (206) on a GUI of a client (e.g., 110A, FIG. 1)); and/or (vi) store (temporarily or permanently) information/data related to (i)-(v) in the storage/memory resource of the IN (200).

One of ordinary skill will appreciate that the analyzer (204) may perform/provide other functionalities without departing from the scope. When providing its functionalities, the analyzer (204) may perform all, or a portion, of the methods illustrated in FIGS. 3-5.2. The analyzer (204) may be implemented using hardware, software, or any combination thereof.

In one or more embodiments, the engine (206) may include functionality to, e.g.: (i) receive an instruction (or a command) to generate a model (e.g., an ML model, a trained model, etc.) that predicts a net operating income (NOI) for an asset; (ii) receive an instruction (or a command) to generate a model (e.g., an ML model, a trained model, etc.) that provides an explanation (e.g., a visualization or explanation dataset) of how an output of a model was generated by explaining which inputs caused the output and how much each input was responsible for the output (described below); (iii) generate, using a previously-generated model, a predicted NOI for one or more assets (e.g., for the assets in the augmented dataset described above); (iv) generate an explanation dataset that includes deviations from a baseline dataset for one or more characteristics associated with each asset; (v) generate a visualization for the explanation dataset that illustrates the explanation dataset in a manner which is easier for a user to digest; (vi) initiate a display of visualizations generated by the engine (206) on a GUI of a client (e.g., 110A, FIG. 1)); and/or (vii) store (temporarily or permanently) information/data related to (i)-(vi) in a storage/memory resource of the IN (200).

In one or more embodiments, generation of a “trained model” is a statistical/ML approach that generates the trained model that predicts an NOI value for an asset, such as one contained within the AD. The engine (206) may generate a “trained model” in two steps: (a) the “feature engineering and feature selection” step, and (ii) the “model selection and model tuning” step.

As used herein, (i) “feature engineering” is a process by which the engine (206) curates the characteristics and data that the trained model will consider to predict an NOI, and (ii) “feature selection” is a process by which the engine (206) chooses which characteristics/features the trained model will consider to predict the NOI.

As used herein, (i) “model selection” is a process by which the engine (206) selects optimal modeling approaches to use for predicting n NOI, and (ii) “model tuning” is a process by which the engine (206) can configure/parameterize a modeling approach to improve its performance for predicting the NOI.

One of ordinary skill will appreciate that the engine (206) may perform/provide other functionalities without departing from the scope disclosed herein. When providing its functionalities, the engine (206) may perform all, or a portion, of the methods illustrated in FIGS. 3-5.2. The engine (206) may be implemented using hardware, software, or any combination thereof.

In one or more embodiments, the orchestrator (202), the analyzer (204), and the engine (206) may be utilized in isolation and/or in combination to provide the above-discussed functionalities. These functionalities may be invoked using any communication model including, for example, message passing, state sharing, memory sharing, etc. By doing so, the IN (200) may address issues related to data security, integrity, and availability proactively.

Further, some of the above-discussed functionalities may be performed using available resources or when resources of the IN (200) are not otherwise being consumed. By performing these functionalities when resources are available, these functionalities may not be burdensome on the resources of the IN (200) and may not interfere with more primary workloads performed by the IN (200).

FIG. 3 shows a method for generating a training data for a model that outputs a predicted NOI for an asset in accordance with one or more embodiments. Preparing the training data provides a dataset that, when used to train a model, may cause the model to be capable of producing more accurate outputs. For example, a model is basing all of its outputs on training data. Thus, having a properly curated training dataset is vital to the accuracy of the model that is trained using the training dataset. In addition, different sources of data may use vastly different data input regimes that should be standardized in the preparation of a training dataset to enable the model to recognize pieces of data as referring to the same type and/or category. Further, different datasets may include overlapping information, and should be curated such that the model treats the overlapping information as duplicative rather than multiple data points that happen to be identical. In addition, as described above, a number of different datasets may be gathered and utilized by the system described herein. However, there is a need to associate certain items within the datasets to provide a more complete picture of an asset. For example, one dataset may include a building's square footage and location, while another may include the building's tenant information and income, while still another dataset includes the economic and demographic data of the area surrounding the building. Each of these items may materially affect the NOI and predicted NOI of the building, but, without an association between these datasets, the model is unable to account for these data points. Thus, the method described in FIG. 3 provides a method for generating a training dataset that accounts for the above issues.

Turning now to FIG. 3, the method shown in FIG. 3 may be executed by, for example, the above-discussed orchestrator (e.g., 202, FIG. 2) and the analyzer (e.g., 204, FIG. 2). Other components of the system (100) illustrated in FIG. 1 may also execute all or part of the method shown in FIG. 3.1 without departing from the scope described herein.

In Step 300, the orchestrator obtains (or retrieves) an AD (e.g., existing contracts, financial metrics, etc.) from the assets database (e.g., 120, FIG. 1). The orchestrator may then send the AD to the analyzer. In one or more embodiments, the AD may be obtained/accessed (for example, by querying the assets database) to obtain data. Certain details of the AD are described above in reference to FIG. 1.

In one or more embodiment, Step 300 also includes the orchestrator obtaining (or retrieving) an LD from the location information database (e.g., 130, FIG. 1). The orchestrator may then send the LD to the analyzer. In one or more embodiments, the LD may be obtained/accessed (for example, by querying the location information database) to obtain data. Certain details of the LD are described above in reference to FIG. 1.

In Step 302, the analyzer analyzes the AD to generate and associate identifiers for each asset in the AD to obtain a modified AD. In one or more embodiments, the assets contained within the asset dataset are each associated with a different structure or portion of a structure at a particular location. However, the asset may not be referred to in the same manner, thereby providing a challenge in associating all of the collected data with the specific asset. For example, one building may be referred to in a number of different manners in different datasets, or even within the same dataset. In another example, the data entered is intended to be the same, but is not (e.g., the data entry may be misspelled). In one or more embodiments, a user/customer may define an asset that does not align one-to-one with a tax lot/parcel, or with an address. For example, the model (described above) may be associated with one or more tax lots, zero or more assets, and multiple addresses (e.g., assets and units that have at least one mailing address each). Thus, providing a common identifier with the asset may provide an easier method to associate data with the asset. In one or more embodiments, the analyzer utilizes the LD to associate an identifier for each asset. In one or more embodiments, the identifier can be in any suitable form, such as a fingerprint, address, internal code, etc.

In Step 304, the orchestrator obtains (or retrieves) an EDD from the demographics database (e.g., 124, FIG. 1). The orchestrator may then send the EDD to the analyzer. In one or more embodiments, the EDD may be obtained/accessed (for example, by querying the demographics database) to obtain data. Certain details of the EDD are described above in reference to FIG. 1.

In Step 306, the analyzer associates at least a portion of the EDD with each asset in the modified AD to obtain a combined dataset. As described above, an asset on its own may be insufficient to provide the full picture regarding an NOI and/or predicted NOI for an asset. In one or more embodiments, the EDD contains information about the area surrounding the asset (e.g., at any scale, including only an area immediately surrounding the asset, a regional area (i.e., a metropolitan and/or state-wide region), or a national area). By combining the EDD with the modified AD, the analyzer may associate additional, relevant data with an asset, thereby providing a more complete picture of data that has a material effect on the value of an asset.

In Step 308, the analyzer receives filter criteria. In one or more embodiments, the raw data may include certain pieces of data that are irrelevant and/or abnormal for at least one reason. As such, it may be advantageous to remove certain pieces of data so that those pieces of data do not have an outsized effect on the model. For example, including an asset that is worth many times more than other similar assets (i.e., an outlier) may not be useful for a model that analyzes data more similar to the other assets. In one or more embodiments, the filter criteria is received from an entity (e.g., a user/customer of a client (e.g., 110A, 110B, etc., FIG. 1), an administrator terminal, etc.) that wants to remove certain pieces of data from the combined dataset. In one or more embodiments, the filter criteria is received from a database and may be based on other criteria such as regulations, export controls, or other legal requirements. In one or more embodiments, the filter criteria may include any other criteria without departing from the scope described herein.

In Step 310, the analyzer applies the filter criteria to the combined dataset to obtain a training dataset. In one or more embodiments, the method may end following Step 310.

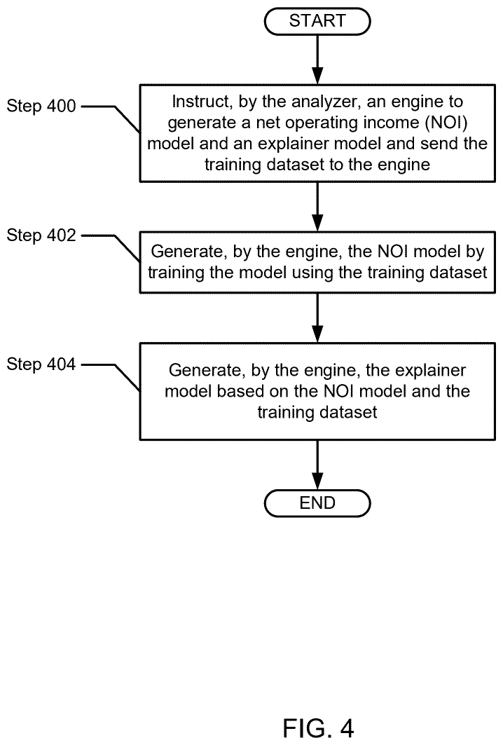

Turning now to FIG. 4, the method shown in FIG. 4 may be executed by, for example, the above-discussed orchestrator, analyzer, and engine (e.g., 206, FIG. 2). Other components of the system (100) illustrated in FIG. 1 may also execute all or part of the method shown in FIG. 4 without departing from the scope disclosed herein.

In Step 400, the analyzer instructs the engine to generate a model (e.g., an ML model, a statistical model, an NOI model, an explainer model etc.) that predicts an NOI value for an asset and provides an explanation dataset that explains how the model arrived at the predicted NOI and sends the training dataset to the engine (e.g., which is obtained from a large volume of actual closed transactions).

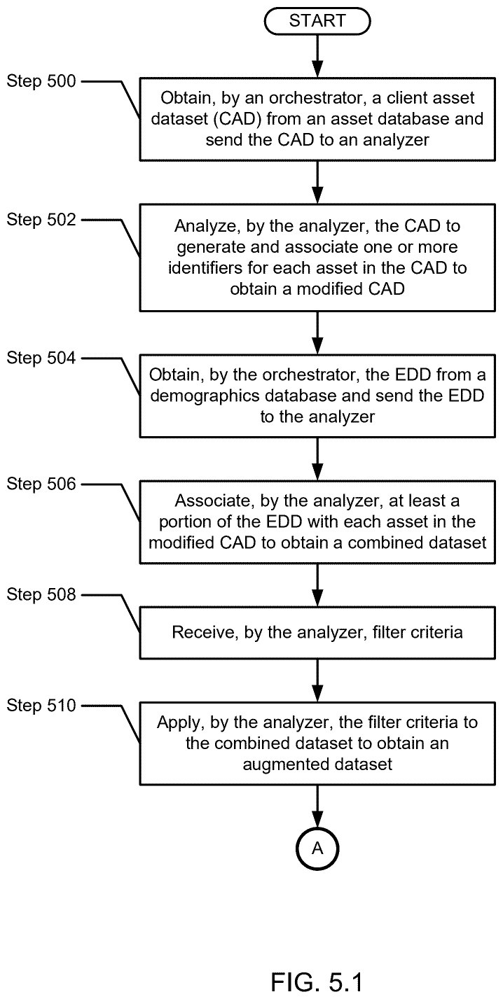

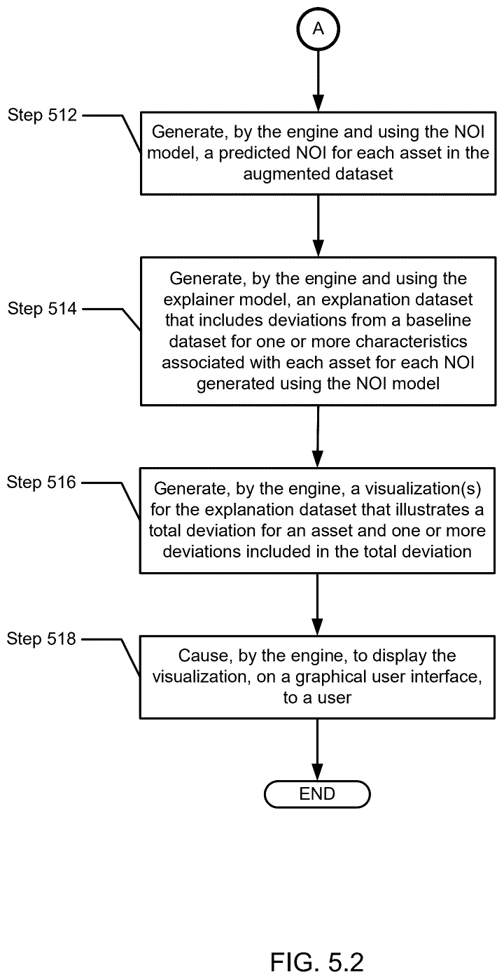

In Step 402, in response to receiving the instruction(s) from the analyzer (in Step 400), the engine generates a model and trains that model to obtain a “trained model”. In order to train the model (with little to no human interaction), the analyzer may use, at least, the training dataset. In one or more embodiments, the trained model may then be used for generating predictions of NOIs and/or explanation datasets for the predicted NOIs (see FIGS. 5.1-5.2).

In Step 404, in response to receiving the instruction(s) from the analyzer (in Step 400), the engine generates a model and trains that model to obtain a “trained model”. In order to train the model (with little to no human interaction), the analyzer may use, at least, the training dataset. In one or more embodiments, the engine utilizes Shapley Additives Explanations to generate explanations.

For example, a model may be able to predict an NOI, but without any explanation of how that predicted NOI was achieved, a user may not be able to use that predicted NOI to take additional actions in response. In one or more embodiments, providing not only an explanation to accompany the predicted NOI, but also a visualization can provide a user many benefits. For example, the user may not be an expert in interpreting model outputs, but may be an expert in interpreting NOIs and the factors driving that prediction. Such a user can utilize the predicted NOI generated by a model and, using the visualization, quickly understand the factors driving the prediction and utilize their own experience take actions in response to such a prediction. For example, when deciding what actions to take with an asset, a user is often in a position to justify their decisions to others, and providing a more detailed analysis as to how a certain decision or prediction was achieved may drive additional human confidence in such a prediction.

In Step 404, after generating the trained model (in Step 402) (e.g., after a load-testing based training is completed and ready for inferencing), the engine initiates notification of an administrator/user (of the IN) about the generated “trained” model. The notification may include, for example (but not limited to): for what purpose the model has been trained, the amount of time that has been spent while performing the training process, etc.

In one or more embodiments, the notification may also indicate whether the training process was completed within the predetermined window, or whether the process was completed after exceeding the predetermined window. The notification may be displayed on a GUI of the IN. In one or more embodiments, the method may end following Step 404.

In one or more embodiments, the methods illustrated in FIGS. 3 and 4 may be performed periodically to generate updated models. In the commercial real estate space, the value of properties are often re-evaluated on a quarterly basis and predictions for future-looking values (including NOIs) are often updated quarterly and/or yearly. As such, large amounts of new data are often generated on at least a quarterly basis and updating the models on a quarterly basis, or even more often, such as a monthly or weekly basis, may provide models whose predictions have increased accuracy.

Turning now to FIGS. 5.1-5.2, the method shown in FIGS. 5.1-5.2 show a method for generating a prediction and a visualization that explains the prediction. As discussed above, even if a prediction is perfect and accounts for all possible factors accurately, the prediction still needs to be trusted by users to be useful to the users. As such, providing an explanation along with the prediction can increase the trust in the prediction generated. Further, presenting the explanation in an easy-to-understand visualization can increase both the amount of understanding retained by a user and increase the rate at which the user understands the information provided by the visualization.

The method shown in FIGS. 5.1-5.2 may be executed by, for example, the above-discussed orchestrator, analyzer, and engine. Other components of the system (100) illustrated in FIG. 1 may also execute all or part of the method shown in FIGS. 5.1-5.2 without departing from the scope disclosed herein.

In Step 500, the orchestrator obtains (or retrieves) a client asset database (CAD) (e.g., existing contracts, financial metrics, etc.) from the assets database (e.g., 120, FIG. 1). In one or more embodiments, the CAD is received via a user input (e.g., a user/customer of a client (e.g., 110A, 110B, etc., FIG. 1). The orchestrator may then send the CAD to the analyzer. In one or more embodiments, the CAD may be obtained/accessed (for example, by querying the assets database) to obtain data. In one or more embodiments, the CAD is a portion of the AD, which is described above in reference to FIG. 1.

In one or more embodiment, Step 500 also includes the orchestrator obtaining (or retrieving) an LD from the location information database (e.g., 130, FIG. 1). The orchestrator may then send the LD to the analyzer. In one or more embodiments, the LD may be obtained/accessed (for example, by querying the location information database) to obtain data. Certain details of the LD are described above in reference to FIG. 1.

In Step 502, the analyzer analyzes the CAD to generate and associate identifiers for each asset in the CAD to obtain a modified CAD. In one or more embodiments, the assets contained within the asset dataset are each associated with a different structure or portion of a structure at a particular location. However, the asset may not be referred to in the same manner, thereby providing a challenge in associating all of the collected data with the specific asset. For example, one building may be referred to in a number of different manners in different datasets, or even within the same dataset. In another example, the data entered is intended to be the same, but is not (e.g., the data entry may be misspelled). In one or more embodiments, a user/customer may define an asset that does not align one-to-one with a tax lot/parcel, or with an address. For example, the model (described above) may be associated with one or more tax lots, zero or more assets, and multiple addresses (e.g., assets and units that have at least one mailing address each). Thus, providing a common identifier with the asset may provide an easier method to associate data with the asset. In one or more embodiments, the analyzer utilizes the LD to associate an identifier for each asset. In one or more embodiments, the identifier can be in any suitable form, such as a fingerprint, address, internal code, etc.

In Step 504, the orchestrator obtains (or retrieves) an EDD from the demographics database (e.g., 124, FIG. 1). The orchestrator may then send the EDD to the analyzer. In one or more embodiments, the EDD may be obtained/accessed (for example, by querying the demographics database) to obtain data. Certain details of the EDD are described above in reference to FIG. 1.

In Step 506, the analyzer associates at least a portion of the EDD with each asset in the modified CAD to obtain a combined dataset. As described above, an asset on its own may be insufficient to provide the full picture regarding an NOI and/or predicted NOI for an asset. In one or more embodiments, the EDD contains information about the area surrounding the asset (e.g., at any scale, including only an area immediately surrounding the asset, a regional area (i.e., a metropolitan and/or state-wide region), or a national area). By combining the EDD with the modified AD, the analyzer may associate additional, relevant data with an asset, thereby providing a more complete picture of data that has a material effect on the value of an asset.

In Step 508, the analyzer receives filter criteria. In one or more embodiments, the raw data may include certain pieces of data that are irrelevant and/or abnormal for at least one reason. As such, it may be advantageous to remove certain pieces of data so that those pieces of data do not have an outsized effect on the model. For example, including an asset that is worth many times more than other similar assets (i.e., an outlier) may not be useful for a model that analyzes data more similar to the other assets. In one or more embodiments, the filter criteria is received from an entity (e.g., a user/customer of a client (e.g., 110A, 110B, etc., FIG. 1), an administrator terminal, etc.) that wants to remove certain pieces of data from the combined dataset. In one or more embodiments, the filter criteria is received from a database and may be based on other criteria such as regulations, export controls, or other legal requirements. In one or more embodiments, the filter criteria may include any other criteria without departing from the scope described herein. In one or more embodiments, Step 508 may be omitted.

In Step 510, the analyzer applies the filter criteria to the combined dataset to obtain an augmented dataset.

In Step 512, the engine generates a predicted NOI for each asset in the augmented dataset using the NOI model (e.g., the NOI model generated in FIG. 4). In one or more embodiments, the predicted NOI includes what the present NOI should be based on the data associated with the asset and/or a future NOI prediction (e.g., in one quarter, six months, one year, two years, five years, or any other suitable timeframe).

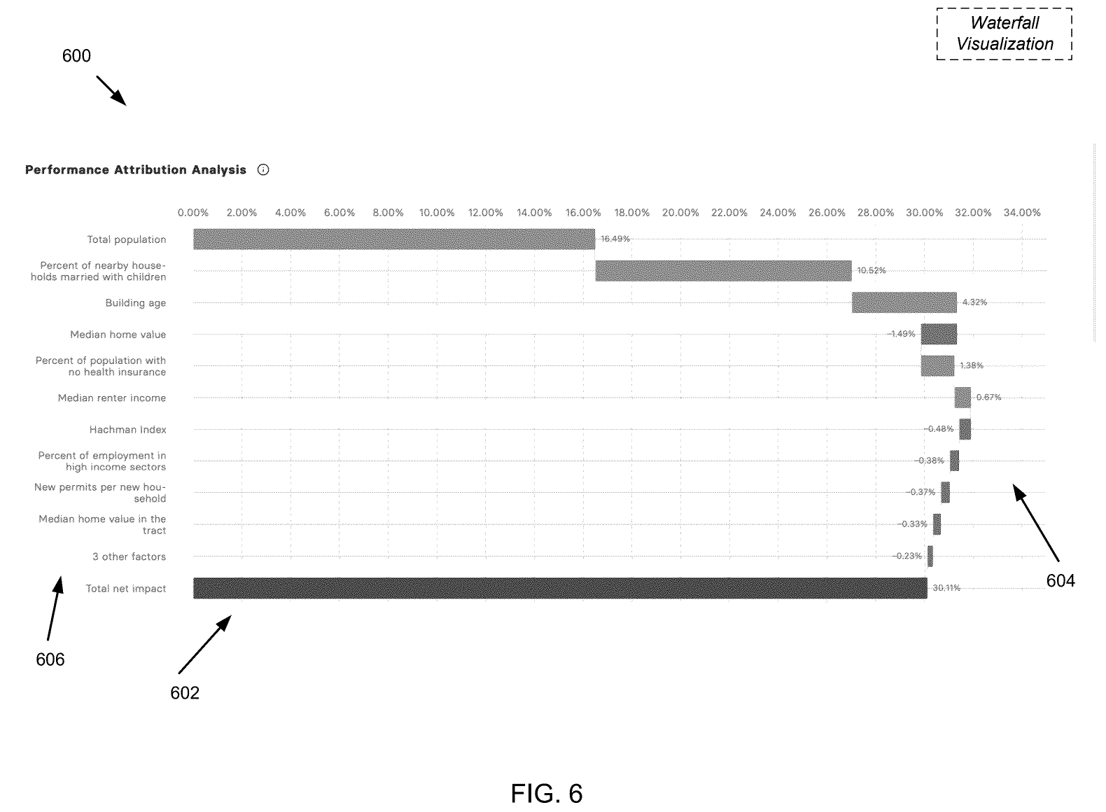

In Step 514, the engine, using the explainer model, generates an explanation dataset that includes deviations from a baseline dataset for one or more characteristics associated with each asset for each NOI generated using the NOI model. In one or more embodiments, the baseline dataset is based on an aggregation of training data used to train the NOI model. In one or more embodiments, the baseline dataset includes the NOI for an average, similar asset as the one being compared. For example, an industrial warehouse may be compared to an average industrial warehouse. In one or more embodiments, the baseline dataset is based on one or more of the data objects included in the EDD, and thus may be based on some regional and/or national dataset. Further, in one or more embodiments, the deviations include any number of data points included in the augmented dataset. In one or more embodiments, the predicted NOI is a present value prediction and the baseline dataset is the actual NOI for the asset. In such an embodiment, the deviations are based on a difference between the predicted NOI and the actual NOI. An example set of deviations is illustrated in FIG. 6.

In Step 516, the engine generates a visualization for the explanation dataset that illustrates a total deviation for an asset and one or more deviations included in the total deviation. In one or more embodiments, the total deviation is a total net impact that includes a total difference between the predicted NOI and the baseline dataset. In one or more embodiments, the visualization includes multiple visualizations and each visualization includes a number of different elements, some of which may be interactive. Additional details regarding the visualizations are provided below in reference to FIGS. 6-8.

In Step 518, the engine causes to display the one or more visualizations on a GUI to a user (e.g., a user/customer of a client (e.g., 110A, 110B, etc., FIG. 1), an administrator terminal, etc.). In response, a client obtains the one or more visualizations and displays the one or more visualizations on the GUI on a display. In one or more embodiments, the one or more visualizations are not displayed all at once, but are made available to a user who may navigate through the visualizations. The method may end following Step 518.

Turning now to FIG. 6, FIG. 6 shows an example visualization depicting a NOI visualization (600) in accordance with one or more embodiments disclosed herein. In one or more embodiments, the NOI visualization (600) provides a visual explanation regarding one or more factors that lead to the output provided by an NOI model (e.g., using the methods provided in FIGS. 3-5.2 above). In one or more embodiments, the NOI visualization (600) includes a total net impact element (602), deviation elements (604), and a label panel (606). In one or more embodiments, the NOI visualization (600) is provided for multiple assets at one time (e.g., a single NOI visualization may be displayed for a portfolio of assets).

In one or more embodiments, the total net impact element (602) illustrates a total difference between the predicted NOI and an asset from the baseline dataset, both of which are described above. In the present example, the total net impact element (602) illustrates that the total net impact of the deviations is 30.11%. This means that the predicted NOI for the selected asset is 30.11% higher than the asset contained within the baseline dataset.

In one or more embodiments, the deviation elements (604) illustrate the impact of one type from the EDD, and the cumulative impact of the deviation elements (604) is represented by the total net impact element (602). In the present example, eleven deviation elements (604) are illustrated and consist of: total population, percent of nearby households married with children, building age, median home value, percent of population with no health insurance, median renter income, Hachman Index, percent of employment in high income sectors, new permits per new household, median home value in the tract, and other factors.

In one or more embodiments, the deviation elements (604) are displayed in an order based on their respective magnitudes. In the present example, the deviation elements (604) are displayed in a descending order with the highest magnitude element at the top. In one or more embodiments, the deviation elements (604) are displayed in an ascending order, from left-to-right, from right-to-left, etc.

In one or more embodiments, the deviation elements (604) are displayed in a waterfall manner in which deviation elements associated with a positive number extend in a first direction along the GUI and deviation elements associated with a negative number extend in a second direction along the GUI, opposite the first direction and an end point of each of the deviation elements vertically aligns with a start point of a directly subsequent deviation element. In the present example, the positive deviation elements (604) extend to the right of the GUI and the negative deviation elements extend to the left of the GUI. As such, a negative deviation element (604) that follows a positive deviation element (604) has some vertical overlap in the deviation elements (604) (e.g., the deviation element associated with the building age and the deviation element associated with the median home value). Likewise, a positive deviation element (604) that follows a negative deviation element (604) has some vertical overlap in the deviation elements (604) (e.g., the deviation element associated with the median home value and the deviation element associated with percent of population with no health insurance). Accordingly, the deviation elements create a waterfall-like visual effect where the deviation element (604) ‘falls’ into the total net impact element (602).

In one or more embodiments, the total net impact element (602) and the deviations elements (604) are color-coded. In one or more embodiments, deviation elements (604) associated with positive numbers are green, deviation elements (604) associated with negative numbers are red, and the total net impact element (602) is blue. Other colors may be used without departing from the scope described herein.

In one or more embodiments, the total effect of the visual elements provided in FIG. 6 is an intuitive visualization that a user can immediately understand what the total net impact is, what factors are diving that total net impact, and by how much each factor is driving the total net impact. In one or more embodiments, the visualization provided in FIG. 6 may improve the effectiveness of the prediction generated by the NOI model by enhancing user trust and understanding in the prediction.

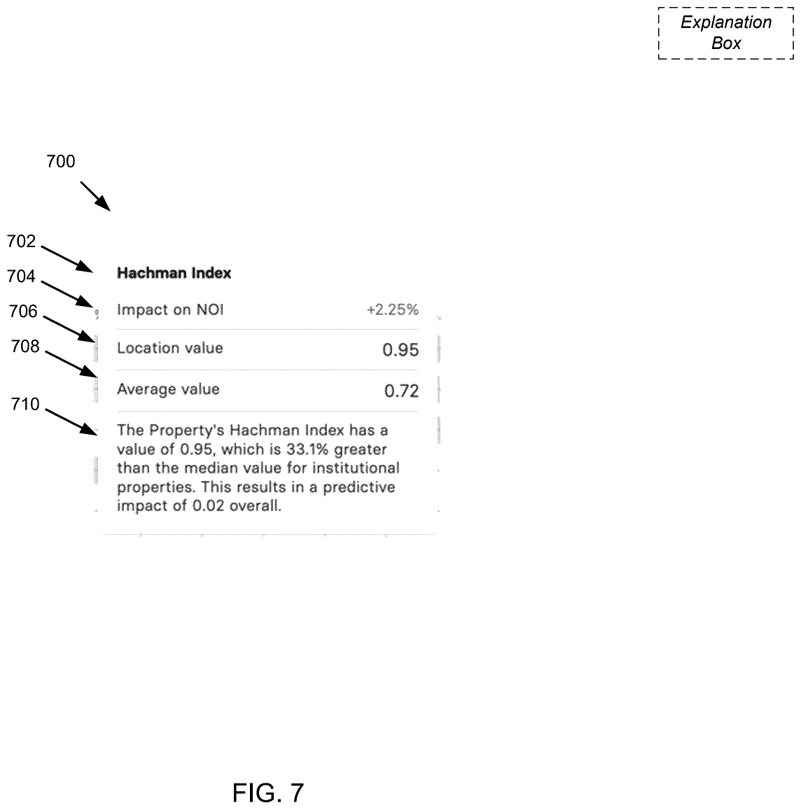

In one or more embodiments, a user can interact with each of the total net impact element (602) and the deviations elements (604) to automatically cause an interactive element (e.g., interactive element (700), FIG. 7) to be displayed. In one or more embodiments, the interaction includes hovering a cursor over the associated visual element, clicking on the associated visual element, or clicking on another object on the GUI.

Turning now to FIG. 7, FIG. 7 shows an example of an interactive element (700) in accordance with one or more embodiments disclosed herein. The interactive element (700) includes a title element (702), an impact element (704), a CAD element (706), a baseline dataset element (708), and an explanation element (710), each of which is described in detail below.

In one or more embodiments, the interactive element (700) is an explanation box that is displayed on the GUI in response to a user interaction. In one or more embodiments, the interactive element (700) is displayed as an overlay over the NOI visualization (600, FIG. 6). In one or more embodiments, the interactive element (700) is displayed separate from the NOI visualization, such as on a separate portion of the GUI or by opening a new page on the GUI.

In one or more embodiments, the title element (702) is a text element that displays the name of the type of data associated with the deviation with which the user interacted. In the present example, the user interacted with the deviation element associated with the Hachman Index.

In one or more embodiments, the impact element (704) is a text element that displays the impact on the NOI prediction generated by the NOI model. In the present example, the Hachman Index provided a positive impact of 2.25%.

In one or more embodiments, the CAD element (706) is a text element that displays the raw value of the type of data contained within the dataset that was the input for the NOI model and on which the output is based. In the present example, the raw value for the Hachman Index for the asset was 0.95.

In one or more embodiments, the baseline dataset element (708) is a text element that displays the raw value of the type of data contained within the baseline dataset used to make the comparison with the analyzed asset. In the present example, the raw value for the Hachman Index from the baseline dataset was 0.72.

In one or more embodiments, the explanation element (710) is a text element that provides a textual summary of the title element (702), the impact element (704), the CAD element (706), and the baseline dataset element (708) contained within the interactive element (700).

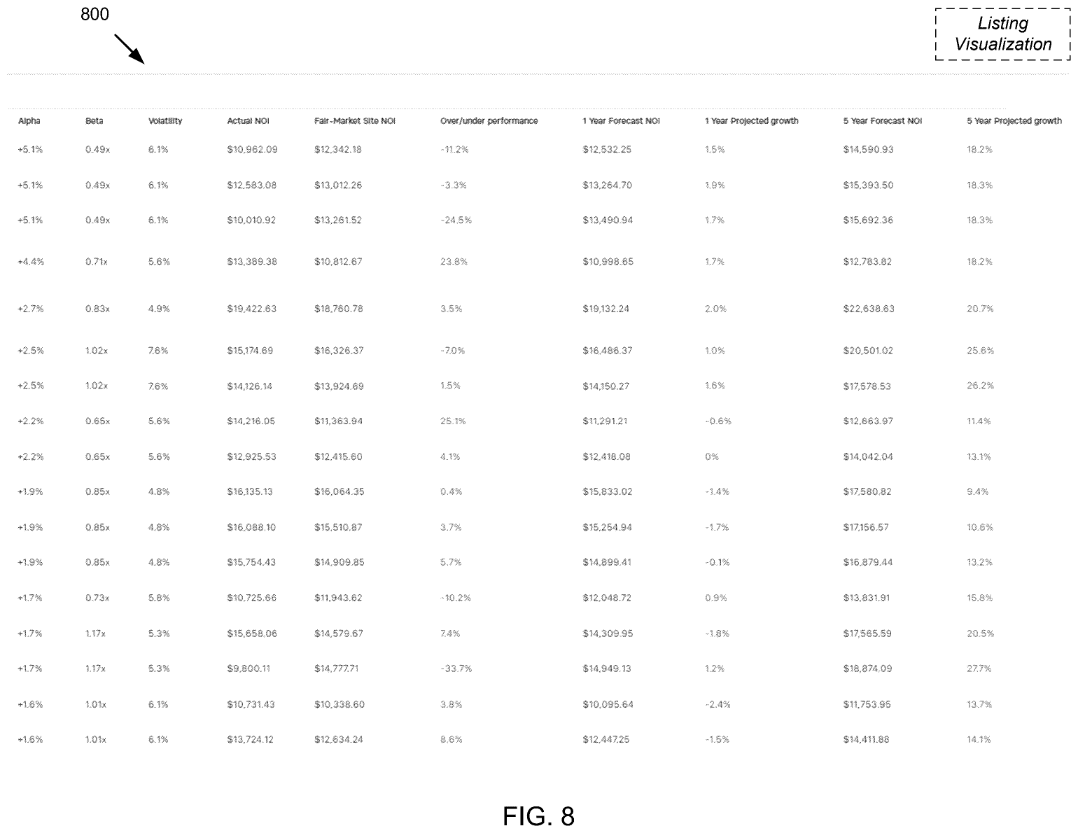

Turning now to FIG. 8, FIG. 8 shows an example of a list view (800) of a number of analyzed assets in accordance with one or more embodiments disclosed herein. In one or more embodiments, each row in the list view is associated with a separate asset contained within the dataset that was the input for the NOI model and on which the output is based. In one or more embodiments, the list view (800) contains a number of different elements that may be associated with input data and output data.

In the present example, for each asset, the list view (800) includes an element for an alpha value, a beta value, a volatility value, an actual NOI, a fair-market site NOI, over/under performance, 1 year forecast NOI, 1 year projected grown, 5 year forecast NOI, and 5 year projected growth. The elements included in the list view (800) may include other elements without departing from the scope disclosed herein. In one or more embodiments, the alpha value indicates the excess return of an asset compared to a benchmark (e.g., a benchmark contained within the baseline dataset). In one or more embodiments, the beta value indicates the volatility of an asset when compared to a benchmark (e.g., a benchmark contained within the baseline dataset).

In one or more embodiments, interaction with one of the rows in the list view (800) automatically causes NOI visualization to be displayed on the GUI on a display. In one or more embodiments, the interaction includes hovering a cursor over the associated row, clicking on the associated row, or clicking on another object on the GUI.

Turning now to FIG. 9, FIG. 9 shows a diagram of a computing device in accordance with one or more embodiments disclosed herein.

In one or more embodiments, the computing device (900) may include one or more computer processors (902), non-persistent storage (904) (e.g., volatile memory, such as RAM, cache memory), persistent storage (906) (e.g., a non-transitory computer readable medium, a hard disk, an optical drive such as a CD drive or a DVD drive, a Flash memory, etc.), a communication interface (912) (e.g., Bluetooth interface, infrared interface, network interface, optical interface, etc.), an input device(s) (910), an output device(s) (908), and numerous other elements (not shown) and functionalities. Each of these components is described below.

In one or more embodiments, the computer processor(s) (902) may be an integrated circuit for processing instructions. For example, the computer processor(s) (902) may be one or more cores or micro-cores of a processor. The computing device (900) may also include one or more input devices (910), such as a touchscreen, keyboard, mouse, microphone, touchpad, electronic pen, or any other type of input device. Further, the communication interface (912) may include an integrated circuit for connecting the computing device (900) to a network (e.g., a LAN, a WAN, Internet, mobile network, etc.) and/or to another device, such as another computing device.

In one or more embodiments, the computing device (900) may include one or more output devices (908), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (902), non-persistent storage (904), and persistent storage (906). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for providing a visualization for a graphical user interface (GUI) explaining an output, the method comprising:
obtaining, by an orchestrator, a client asset dataset (CAD) and an economic and demographic dataset (EDD), wherein the CAD comprises a plurality of assets;
analyzing, by an analyzer, the CAD that is received from the orchestrator to generate and associate an identifier for each of the plurality of assets, wherein the identifier comprises location data;
associating, by the analyzer, at least a portion of the EDD with each of the plurality of assets to obtain a combined dataset, wherein each asset in the combined dataset comprises the associated identifier and the associated portion of the EDD;
generating, by an engine and using a trained model, a predicted net operating income (NOI) and an explanation dataset for each asset in the combined dataset,
wherein the combined dataset is used as an input to the trained model, and
wherein the explanation dataset comprises deviations from a baseline dataset,
wherein the baseline dataset is based on an aggregation of training data used to train the trained model; and
generating, by the engine, for at least one of the assets in the combined dataset, the visualization based on the predicted NOI and the explanation dataset,
wherein the visualization comprises:
a total net impact element illustrating a total difference between the predicted NOI and the baseline dataset; and
deviation elements, each illustrating a corresponding one of the deviations,
wherein each of the deviations is based on one type from the EDD,
wherein the deviation elements are displayed in a stacked order based on a magnitude of the associated deviation,
wherein deviation elements associated with a positive number are configured to extend in a first direction along the GUI and deviation elements associated with a negative number are configured to extend in a second direction along the GUI, opposite the first direction, and
wherein a magnitude of extension of each deviation element is based on the magnitude of the associated deviation.

2. The method of claim 1, wherein the visualization further comprises:
an interactive element associated with each of the deviation elements, wherein interaction with the interactive element automatically causes an explanation box to be displayed that displays associated values from the combined dataset and the baseline dataset.

3. The method of claim 1, further comprising:
generating, by the engine, a second visualization comprising a list view of at least a portion of the combined dataset, at least a portion of the explanation dataset, and the predicted NOI.

4. The method of claim 3, wherein the predicted NOI comprises a one-year forecast and a five-year forecast.

5. The method of claim 1, wherein an end point of each of the deviation elements vertically aligns with a start point of a directly subsequent deviation element, and wherein the first and second directions are in a horizontal direction.

6. A method for displaying a visualization on a graphical user interface (GUI) explaining an output, the method comprising:
providing, to an infrastructure node and based on a user input, a client asset dataset (CAD) wherein the CAD comprises a plurality of assets, and wherein the infrastructure node is configured to:
analyze, by an analyzer, the CAD that is received from the orchestrator to generate and associate an identifier for each of the plurality of assets, wherein the identifier comprises location data;
associate, by the analyzer, at least a portion of an economic and demographic dataset (EDD) with each of the plurality of assets to obtain a combined dataset, wherein each asset in the combined dataset comprises the associated identifier and the associated portion of the EDD;
generate, by an engine and using a trained model, a predicted net operating income (NOI) and an explanation dataset for each asset in the combined dataset,
wherein the combined dataset is used as an input to the trained model, and
wherein the explanation dataset comprises deviations from a baseline dataset, wherein the baseline dataset is based on an aggregation of training data used to train the trained model; and
generate, by the engine, for at least one of the assets in the combined dataset, the visualization based on the predicted NOI and the explanation dataset, wherein the visualization comprises:
a total net impact comprising a total difference between the predicted NOI and the baseline dataset; and
the deviations, wherein each of the deviations is based on one type from the EDD, and wherein the deviations are displayed in an order based on the magnitude of the deviation;
obtaining, from the infrastructure node, the visualization; and
displaying the visualization on the GUI on a display.

7. The method of claim 5, wherein the visualization further comprises:
an interactive element associated with each of the deviations, wherein interaction with the interactive element automatically causes an explanation box to be displayed that displays associated values from the combined dataset and the baseline dataset.

8. The method of claim 5, wherein the infrastructure node is further configured to:
generate, by the engine, a second visualization comprising a list view of at least a portion of the combined dataset, at least a portion of the explanation dataset, and the predicted NOI.

9. The method of claim 5, wherein the predicted NOI comprises a one-year forecast and a five-year forecast.

10. The method of claim 5, wherein the infrastructure node is further configured to:
analyze, by the analyzer, a client asset dataset that is received from the orchestrator to generate and associate an identifier for each of the plurality of assets, wherein the identifier comprises location data.

11. The method of claim 9, wherein each asset in the combined dataset comprises the associated identifier and the associated portion of the EDD.

12. A non-transitory computer readable medium comprising computer readable program code, which when executed by a computer processor enables the computer processor to perform a method for providing a visualization explaining an output, the method comprising:
generating, by an engine and using a trained model, a predicted net operating income (NOI) and an explanation dataset for each asset in an asset dataset,
wherein the asset dataset is used as an input to the trained model, and
wherein the explanation dataset comprises a plurality of deviations from a baseline dataset; and
generating, by the engine, for at least one of the assets in the combined dataset, the visualization based on the predicted NOI and the explanation dataset,
wherein the visualization comprises:
a total net impact comprising a total difference between the predicted NOI and the baseline dataset; and
the deviations, wherein each of the deviations is based on one type from an economic and demographic dataset (EDD), and wherein the deviations are displayed in an order based on the magnitude of the deviation.

13. The non-transitory computer readable medium of claim 11, wherein the visualization further comprises:
an interactive element associated with each of the deviations, wherein interaction with the interactive element automatically causes an explanation box to be displayed that displays associated values from the combined dataset and the baseline dataset.

14. The non-transitory computer readable medium of claim 11, wherein the method further comprises:
generating, by the engine, a second visualization comprising a list view of at least a portion of the asset dataset, at least a portion of the explanation dataset, and the predicted NOI.

15. The non-transitory computer readable medium of claim 11, wherein the method further comprises:
associate an identifier for each of a plurality of assets contained within a client asset dataset to generate the asset dataset, wherein the identifier comprises location data.

16. The non-transitory computer readable medium of claim 11, wherein the method further comprises:
associating, by an analyzer, at least a portion of an economic and demographic dataset (EDD) with each of a plurality of assets to obtain a combined dataset, wherein the asset dataset is the combined dataset.

17. The non-transitory computer readable medium of claim 16, wherein each asset in the combined dataset comprises the associated identifier and the associated portion of the EDD.

18. The non-transitory computer readable medium of claim 11, wherein the method further comprises:
associating, by an analyzer, at least a portion of an economic and demographic dataset (EDD) with each of a plurality of assets to obtain a combined dataset; and
applying, by the analyzer, filter criteria received from a user to the combined dataset to obtain an augmented dataset, wherein the asset dataset is the augmented dataset.

19. The non-transitory computer readable medium of claim 11, wherein the baseline dataset is generated using a national dataset of assets having a same type as the at least one of the assets.

20. The non-transitory computer readable medium of claim 11, wherein the baseline dataset is generated using a regional asset dataset having a same type as the at least one of the assets.
